(19) United States
(12) Patent Application Publication
(10) Pub. No.: US 2010/0097285 A1
(43) Pub. Date: Apr. 22, 2010

(54) FOLDING DIPOLE ANTENNA

(75) Inventors: Toshiteru Hayashi, Yokohama-shi (JP); Yoshio Koyanagi, Yokohama-shi (JP)

Correspondence Address: Christensen O'Connor Johnson Kindness PLLC, 1420 Fifth Avenue, Suite 2800, Seattle, WA, 98101-2347, US

(73) Assignee: PANASONIC CORPORATION, Kadoma-shi, Osaka (JP)

(21) Appl. No.: 12/529,075

(22) PCT Filed: Mar. 6, 2007
(86) PCT No.: PCT/JP2007/054299

§ 371 Date: Aug. 28, 2009

(51) Int. Cl. H01Q 9/26

(52) U.S. Cl. 343/803

(57) ABSTRACT

A folding dipole antenna having remarkably multi-band characteristics as compared with prior art. Element width at the short portions (12d, 11d) of any one of an upper element (12) or a lower element (11) is set wider than that of the other element, and the element width at the long part of the upper element (12) or the lower element (11) on the feed side is set wider than that of the element on the non-feed side.

### TECHNICAL FIELD

The present invention relates to a small-sized antenna apparatus built in a portable terminal. More particularly, the present invention relates to a structure of a half-folded dipole antenna.

### BACKGROUND ART

In recent years, in the field of radio communication, with an increasing demand for high-speed and large capacity communication (data transmission), MIMO (Multiple-Input Multiple-Output) technology has been known, and various researches and developments of this MIMO technology have been underway. This MIMO technology provides multi-inputs and multi-outputs via radio channels by providing a plurality of antennas on both the transmitting side and the receiving side. This makes it possible to improve the spatial use efficiency and improve transmission speed and transmission capacity.

Further, in parallel with the demand for high-speed and large capacity communication, there is an increasing demand for a portable terminal equipped with a plurality of applications (i.e. radio systems). To support these applications, a multi-band antenna technology to support different frequency bands per radio system requires.

Meanwhile, portable terminals themselves are in the trend of having smaller and thinner. For this reason, a technology for small-sized antenna built in a portable terminal is needed. Further, MIMO antennas require low correlation characteristics between the antennas and multi-band antennas require characteristics of wide band and multi resonant (i.e. having a plurality of resonance points).

Conventionally, a built-in, half-folded dipole antenna is proposed for a demand for miniaturization (see Non-Patent Documents 1 and 2).

The structures of the built-in, half-folded dipole antennas disclosed in these Non-Patent Documents 1 and 2 will be explained briefly. FIG. 1A shows a folded loop antenna. FIG. 1B shows a low-profile folded loop antenna having a low height by laying the folded loop antenna of FIG. 1A sideways along a conductor plate.

As shown in FIG. 1C, Non-Patent documents 1 and 2 propose built-in half-folded dipole antennas, which are low-profile and small, and which have wide-band antenna characteristics, by making the low-profile folded loop antenna of FIG. 1B in half at the feeding point. The half-folded dipole antennas proposed in

Non-Patent Documents 1 and 2 are low-profile and small, and have wide-band antenna characteristics, and are suitable for implementing in portable terminals.

Non-Patent Document 1: Hayashida, Morishita, and Koyanagi, “Characteristics of built-in folded monopole antenna for handsets” IEICE, AP2003-269, pp.23-28, 2003.

Non-Patent Document 2: Hayashida, Morishita, and Koyanagi, “Characteristics of built-in folded monopole antenna for handsets” IEICE, AP2004-128, pp.23-28, 2004.

### DISCLOSURE OF INVENTION

### Problems to be Solved by the Invention

It is therefore an object of the present invention to provide a half-folded dipole antenna having wide band, multi frequency antenna characteristics compared to conventional cases.

Further, it is another object of the present invention to provide a portable terminal having characteristics that are more adaptable MIMO communication than conventional cases. Further, it is also an object of the present invention to provide a half-folded dipole antenna having characteristics that are more adaptable multi-band communication than conventional cases.

### Means for Solving the Problem

According to an aspect of the half-folded dipole antenna of the present invention, a half-folded dipole antenna adopts a configuration including: a first antenna element formed in a shape of a letter J, one end of the first antenna element being connected with a conductor plate; and a second antenna element formed in the shape of the letter J, having element widths that are different from the element widths of the first antenna element, and folded from the other end of the first antenna element to overlap with the first antenna element at a distance, one end of the second antenna element being connected with the conductor plate.

According to the configuration, it is possible to realize a half-folded dipole antenna having wide-band frequency characteristics compared to conventional cases by making different the element widths of the first antenna element and second antenna element.

According to an aspect of the portable terminal of the present invention, a portable terminal adopts a configuration including: a first half-folded dipole antenna and second half-folded dipole antenna that are placed along upper corners of a housing of the portable terminal, wherein the first half-folded dipole antenna and second half-folded dipole antenna each include: a first antenna element formed in a shape of a letter J, one end of the first antenna element being connected with a conductor plate;

and a second antenna element formed in the shape of the letter J, folded from the other end of the first antenna element to overlap with the first antenna element at a distance, one end of the second antenna element being connected with the conductor plate.

According to this configuration, it is possible to place the antennas efficiently in spaces at ends of the housing amongst various electronic parts in the housing, and, additionally, to reduce the correlation between the antennas, so that it is possible to realize a portable terminal having good MIMO communication performance.

According to another aspect of the half-folded dipole antenna of the present invention, a half-folded dipole antenna adopts a configuration including: a first antenna element formed in a shape of a letter J, one end of the first antenna element being connected with a conductor plate; a second antenna element formed in the shape of the letter J, folded from the other end of the first antenna element to overlap with the first antenna element at a distance, one end of the second antenna element being connected with the conductor plate; a feed connected with the end of the first antenna element; and a resonant circuit connected with the end of the second antenna element.

According to this configuration, it is possible to realize a half-folded dipole antenna having wide band and multi resonance (multi band) characteristics by providing a resonant circuit in the half-folded dipole antenna.

### Advantageous Effects of Invention

According to the present invention, a half-folded dipole antenna having wide-band frequency characteristics compared to conventional cases, having characteristics more adequate MIMO communication than conventional cases and/or having characteristics more adequate multi-band communication than conventional cases.

### BRIEF DESCRIPTION OF DRAWINGS

FIG. 1A shows a folded loop antenna, FIG. 1B shows a low-profile folded loop antenna, and FIG. 1C shows a half-folded dipole antenna;

FIG. 2 is a perspective view showing the schematic configuration of the half-folded dipole antenna according to the embodiments;

FIG. 3 shows the frequency characteristics when the width of a short part of an upper element is wider than the width of a short part of a bottom element;

FIG. 4 shows the frequency characteristics when the width of the short part of the bottom element is wider than the width of the short part of the upper element;

FIG. 5 shows the frequency characteristics when the width of a long part of the bottom element is wider than the width of a long part of the upper element;

FIG. 6 shows the frequency characteristics when the width of a long part of the upper element is wider than the width of a long part of the bottom element;

FIG. 7 shows an example of the frequency characteristics of the half-folded dipole antenna according to Embodiment 1;

FIG. 8 shows the configuration of Embodiment 2;

FIG. 9 shows the radiation pattern of half-folded dipole antenna 10A;

FIG. 10 shows the radiation pattern of half-folded dipole antenna 10B;

FIG. 11 shows the configuration of Embodiment 3; and

FIG. 12 shows the frequency characteristics according to Embodiment 3.

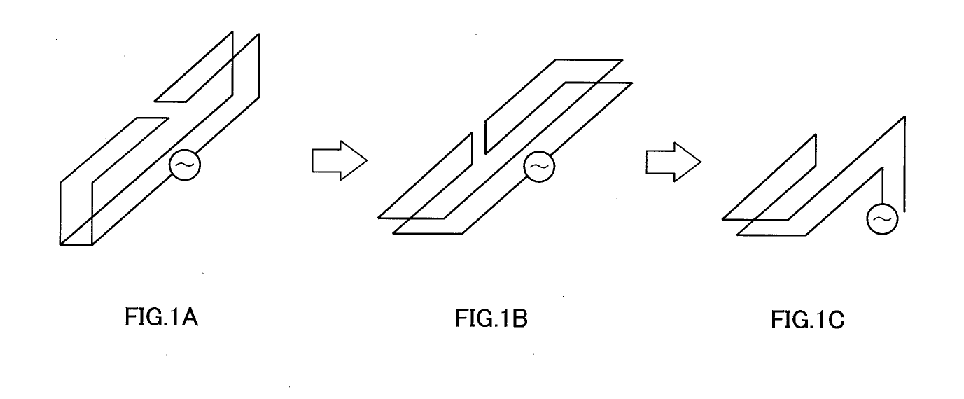

### BEST MODE FOR CARRYING OUT THE INVENTION

Now, embodiments of the present invention will be described in detail with reference to the accompanying drawings.

### (1) Embodiment 1

### (1-1) Schematic Configuration

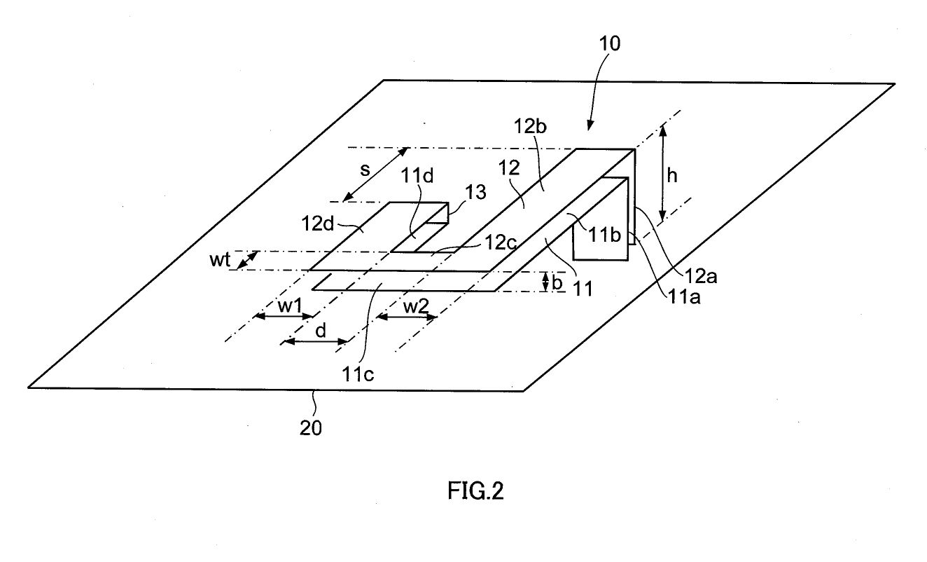

FIG. 2 shows the schematic configuration of the half-folded dipole antenna according to the present embodiment. Half-folded dipole antenna 10 in FIG. 2 has the same configuration as the half-folded dipole antennas disclosed in above Non-Patent Documents 1 and 2. However, half-folded dipole antenna 10 of the present embodiment differs from the half-folded dipole antennas disclosed in Non-Patent Documents 1 and 2 in that the element widths vary between upper element 12 and the width of bottom element 11 vary. In FIG. 2, to simplify the figure, the widths of upper element 12 and the widths of bottom element 11 are drawn such that they are the same width.

Half-folded dipole antenna 10 is formed by the flat, J-shaped bottom element (first antenna element) 11 and upper element (second antenna element) 12 that overlap each other at interval b.

Bottom element 11 is provided parallel to conductor plate 20 above conductor plate 20. One end of bottom element 11 is connected with conductor plate 20. With the present embodiment, a feed is provided at one end of bottom element 11.

Upper element 12 is folded back from the other end of bottom element 11 through fold part 13 to overlap with bottom element 11 in parallel at interval b. Further, one end of upper element 12 is connected with plate conductor 20. With the present embodiment, one end of upper element 12 is grounded.

To be more specific, bottom element 11 and upper element 12 are formed by onset parts 11a and 12b long parts 11b and 12b, middle parts 11c and 12c and short parts 11d and 12d, respectively, whose ends are connected with conductor plate 20.

Here, the shape joining long part 11b, middle part 11c and short part 11d of bottom element 11, makes a J-shape. Similarly, the shape joining long part 12b, middle part 12c and short part 12d of upper element 12, makes a J-shape.

The outside shape of half-folded dipole antenna 10 is defined by seven parameters, w1, w2, wt, d, s, b and h shown in the figure. Here, parameter w1 represents the widths of short parts 11d and 12d, parameter w2 represents the widths of long parts 11b and 12b, parameter wt represents the widths of middle parts 11c and 12c, parameter d represents the lengths of middle parts 11c and 12c, parameter s represents the differences of lengths between long parts 11b and 12b and short parts 11d and 12d, parameter b represents the interval between bottom element 11 and upper element 12, and parameter h represents the height of onset part 12a.

Incidentally, the above-described Non-Patent Documents 1 and 2 show the frequency characteristics of these parameters w1, w2, wt, d, s, b and h are set to predetermined values.

With the present embodiment, amongst the above-described parameters w1, w2, wt, d, s, b and h as parameters to define the outside shape of half-folded dipole antenna 10, it is proposed that w1, the width of short side parts 11d and 12d, and w2, the width of long parts 11b and 12b, each vary between bottom element 11 and upper element 12.

That is, when the width of short part 11d of bottom element 11 is w1_{bottom} and the width of short part 12d of upper element 12 is w1ᵤₚₚₑᵣ, short parts 11d and 12d of bottom element 11 and upper element 12 are formed such that the relationship is w1_{bottom}≠w1ᵤₚₚₑᵣ. Further, when the width of long part 11b of bottom element 11 is w2_{bottom} and the width of long part 12b of upper element 12 is w2ᵤₚₚₑᵣ, long parts 11b and 12b of bottom element 11 and upper element 12 are formed such that the relationship is w2_{bottom}≠w2ᵤₚₚₑᵣ.

By this means, it is possible to realize wider band or control frequency characteristics (to shift all frequency bands that can be used for reception to desired frequencies) without changing the total length of the antenna.

### (1-2) Selecting Width Ratios in the Upper Element and Bottom Element

Next, how to define a ratio between the width of short part 11d of bottom element 11 and width of short part 12d of upper element 12 and how to define a ratio between the width of long part 11b of bottom element 11 and the width of long part 12b of upper element 12, will be explained in detail. Here, the following experimental results have been acquired.

<1>In the case where the width of short part 12d of upper element 12, w1ᵤₚₚₑᵣ, is wider than the width of short part 11d of bottom element, w1_{bottom}.

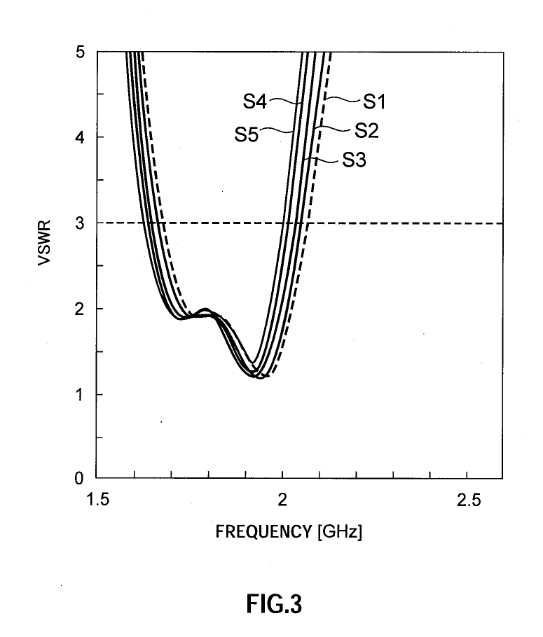

FIG. 3 shows the frequency characteristics of half-folded dipole antenna 10 when the width of short part 11d of bottom element 11, w1_{bottom}=1 mm, the width of long part 11b of bottom element 11, w2_{bottom}=the width of long part 12b of upper element 12, w2ᵤₚₚₑᵣ=1 mm, the length of middle part 11c and 12c, d=5 mm, the width of middle part 11c and 12c, wt=1 mm, the length of onset part 12a, h=7 mm, the difference of length between long part 11b and 12b and short part 11d and 12d, s=12.5 mm, and the interval between the bottom element 11 and upper element 12, b=1 mm are fixed, and when the width of short part 12d of upper element 12, w1ᵤₚₚₑᵣ, keeps widening in 1 mm units.

FIG. 3 shows the frequency characteristics of half-folded dipole antenna 10 when curve S1 is w1ᵤₚₚₑᵣ=1 mm, curve S2 is w1ᵤₚₚₑᵣ=2 mm, curve S3 is w1ᵤₚₚₑᵣ=3 mm, curve S4 is w1ᵤₚₚₑᵣ=4 mm, and curve S5 is w1ᵤₚₚₑᵣ=5 mm.

It is evident from FIG. 3 that, when the width of short part 12d of upper element 12, w1ᵤₚₚₑᵣ, is made wider than the width of short part 11d of bottom element 11, w1_{bottom}, it is possible to keep lowering the frequency almost without changing the frequency bandwidth.

<2> In the case where the width of short part 11d of bottom element 11, w1_{bottom}, is wider than the width of short part 12d of upper element 12, w1ᵤₚₚₑᵣ.

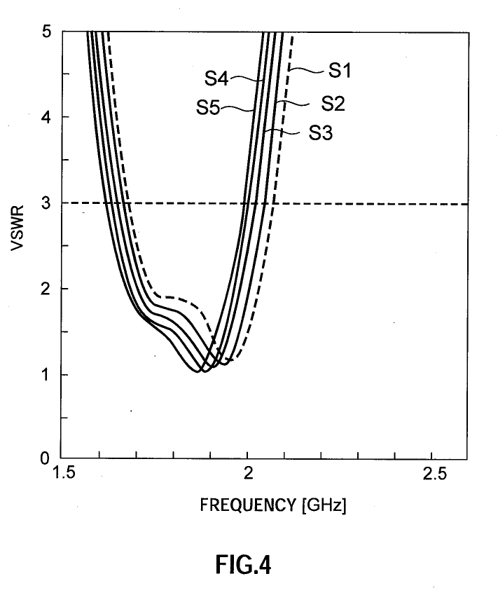

FIG. 4 shows the frequency characteristics of half-folded dipole antenna 10 when the width of short part 12d of upper element 12, w1ᵤₚₚₑᵣ=1 mm, the width of long part 11b of bottom element 11, w1_{bottom}=the width of long part 12b of upper element 12, w2ᵤₚₚₑᵣ=1 mm, d=5 mm, wt=1 mm, h=7 mm, s=12.5 mm, and b=1 mm are fixed, and when the width of short part 11d of bottom element 11, w1_{bottom}, keeps widening in 1 mm units.

FIG. 4 shows the frequency characteristics of half-folded dipole antenna 10 when curve S1 is w1_{bottom}=1 mm, curve S2 is w1_{bottom}=2 mm, curve S3 is w1_{bottom}=3 mm, curve S4 is w1_{bottom}=4 mm, and curve S5 is w1_{bottom}=5 mm.

It is evident from FIG. 4 that, when the width of short part 11d of bottom element 11, w1_{bottom}, is made wider than the width of short part 12d of upper element 12, w1ᵤₚₚₑᵣ, it is possible to keep lowering the frequency almost without changing the frequency bandwidth.

<3> In the case where the width of long part 11b of bottom element 11, w2_{bottom}, is wider than the width of long part 12b of upper element 12, w2ᵤₚₚₑᵣ.

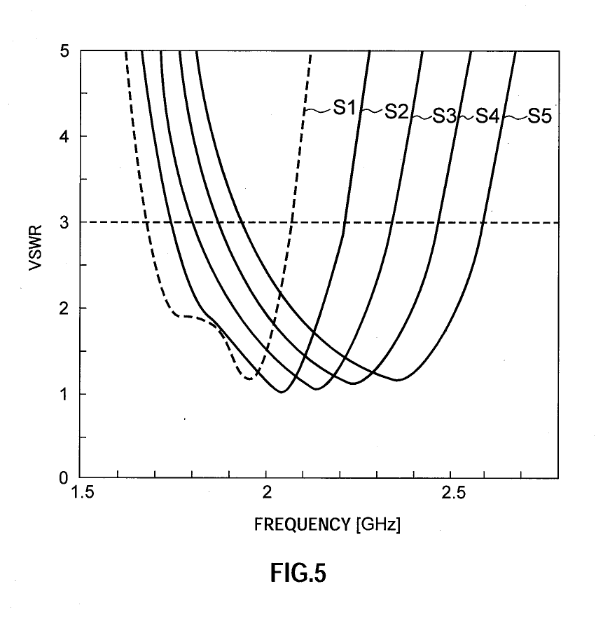

FIG. 5 shows the frequency characteristics of half-folded dipole antenna 10 when the width of long part 12b of upper element 12, w2ᵤₚₚₑᵣ=1 mm, the width of short part 11d of bottom element 11, w1_{bottom}=the width of short part 12d of upper element 12, w1ᵤₚₚₑᵣ=1 mm, d=5 mm, wt=1 mm, h=7 mm, s=12.5 mm, and b=1 mm are fixed, and when the width of long part 11b of bottom element 11, w2_{bottom}, keeps widening in 1 mm units.

FIG. 5 shows the frequency characteristics of half-folded dipole antenna 10 when curve S1 is w2_{bottom}=1 mm, curve S2 is w2_{bottom}=2 mm, curve S3 is w2_{bottom}=3 mm, curve S4 is w2_{bottom}=4 mm, and curve S5 is w2_{bottom}=5 mm.

It is evident from FIG. 5 that, when the width of long part 11b of bottom element 11, w2_{bottom}, is made wider than the width of long part 12b of upper element 12, w2ᵤₚₚₑᵣ, it is possible to keep raising the frequency almost without changing in the frequency bandwidth.

<4> In the case where the width of long part 12b of upper element 12, w2ᵤₚₚₑᵣ, is wider than the width of long part 11b of bottom element 11, w2_{bottom}.

FIG. 6 shows the frequency characteristics of half-folded dipole antenna 10 when the width of long part 11b of bottom element 11, w2_{bottom}=1 mm, the width of short part 11d of bottom element 11, w1 _{bottom}=the width of short part 12d of upper element 12, w1ᵤₚₚₑᵣ=1 mm, d=5 mm, wt=1 mm, h=7 mm, s=12.5 mm, and b=1 mm are fixed, and when the width of long part 12b of upper element 12, w2ᵤₚₚₑᵣ, keeps widening in 1 mm units.

FIG. 6 shows the frequency characteristics of half-folded dipole antenna 10 when curve Si is w2ᵤₚₚₑᵣ=1 mm, curve S2 is w2 upper=2 mm, curve S3 is w2ᵤₚₚₑᵣ=3 mm, curve S4 is w2ᵤₚₚₑᵣ=4 mm, and curve S5 is w2ᵤₚₚₑᵣ=5 mm.

It is evident from FIG. 6 that, when the width of long part 12b of upper element 12, w2ᵤₚₚₑᵣ, is made wider than the width of long part 11b of bottom element 11, w2_{bottom}, the frequency bandwidth is narrower, and therefore it is not adaptable to realize wide band. In this way, the reason the frequency bandwidth is narrower is that, in the present embodiment, the width of upper element 12, in which a feed is not provided, is wider than the width of bottom element 11, in which a feed is provided.

That is, it is evident from <3> and <4> that the element width of long parts 11b and 12b, w2, makes it possible to keep raising the frequency almost without changing the frequency bandwidth by making wider the element width on power supply end than the element width on a non-feed.

Based on the above considerations, it has been found out that all frequencies can be lowered by making wider the element width of one of short parts 12d and 11d in upper element 12 or bottom element 11 than the element width of the other. Further, it has been found out that all frequencies can be raised by making wider the element width of long parts 11d and 12d on the power supply end than the element width of long parts 11d and 12d on the non-feed end, in upper element 12 or bottom element 11.

The half-folded dipole antenna according to the present embodiment makes wider the element width of one of short parts 12d and 11d than the element width of the other, and makes wider the element width of a long part on a feed than the element width of another long part on a non-feed, in upper element 12 or bottom element 11. By this means, half-folded dipole antenna 10 of the configuration in FIG. 2 can realize wide band further.

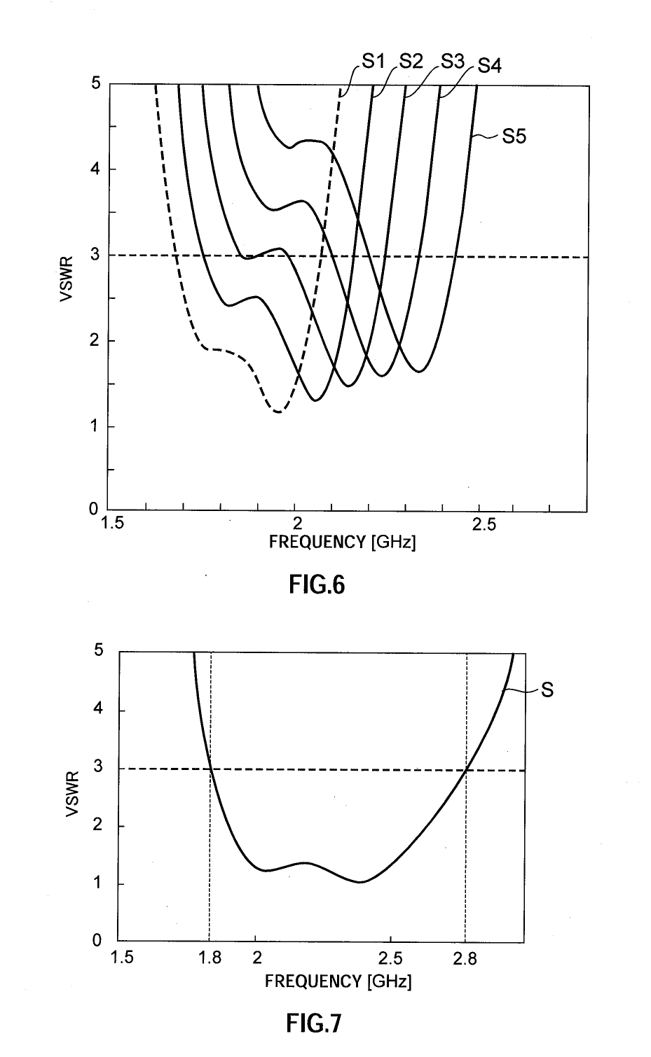

FIG. 7 shows the frequency characteristics of half-folded dipole antenna 10 when the ratio between the width of short part 11d and the width of short part 12d is ⅕ (that is, the width ratio between w1ᵤₚₚₑᵣ=1 mm and w1_{bottom}=5 mm), the ratio between the width of long part 11b and the width of long part 12b is ⅕ (that is, the width ratio between w1ᵤₚₚₑᵣ=1 mm and w1_{bottom}=5 mm, d=5 mm, wt=1 mm, h=7 mm, s =12.5 mm, and b =1 mm. It is evident from the experimental result in FIG. 7 that the configuration according to the present embodiment is able to achieve to realize wide band.

Half-folded dipole antenna 10 according to the present embodiment can change frequencies without lengthening the antenna (that is, without changing “s” in FIG. 2). Further, frequencies change and wide band can be realized by simply changing the ratio between the widths of upper element and bottom element, so that, it is possible to change frequencies and achieve to realize wide band without enlarging the element areas.

### (2) Embodiment 2

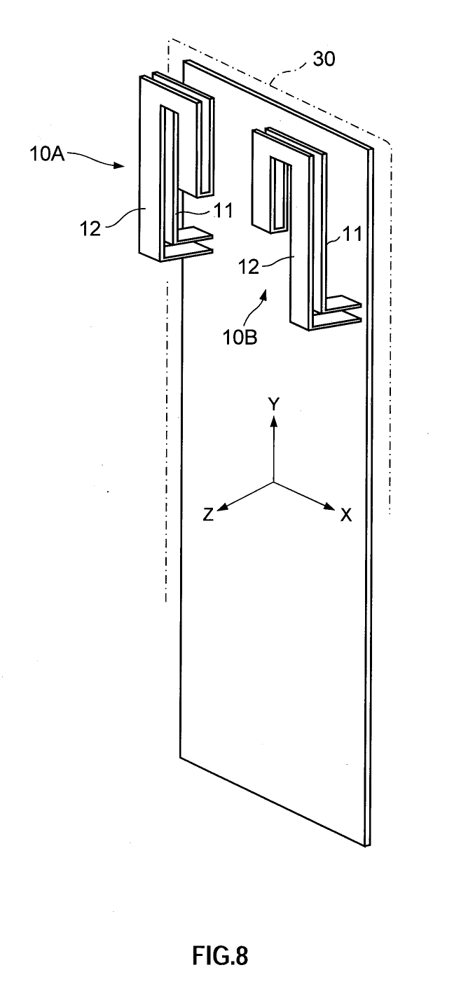

FIG. 8 shows the configuration of Embodiment 2. The feature of the present embodiment includes placing two half-folded dipole antennas 10A and 10B formed in the configuration in FIG. 2 along two upper end corners of housing 30 of a mobile phone device.

To be more specific, two half-folded dipole antennas 10A and 10B are placed such that long parts 11d and 12d meet along the side faces of housing 30 and used in MIMO communication.

According to the present embodiment, it is possible to place the antennas efficiently in spaces at ends of the housing amongst various electronic parts in the housing, and, additionally, to reduce the correlation between antennas, so that it is possible to realize a portable terminal having good MIMO communication performance. Further, wide band can be realized to achieve by applying the configuration in Embodiment 1 to half-folded dipole antennas 10A and 10B.

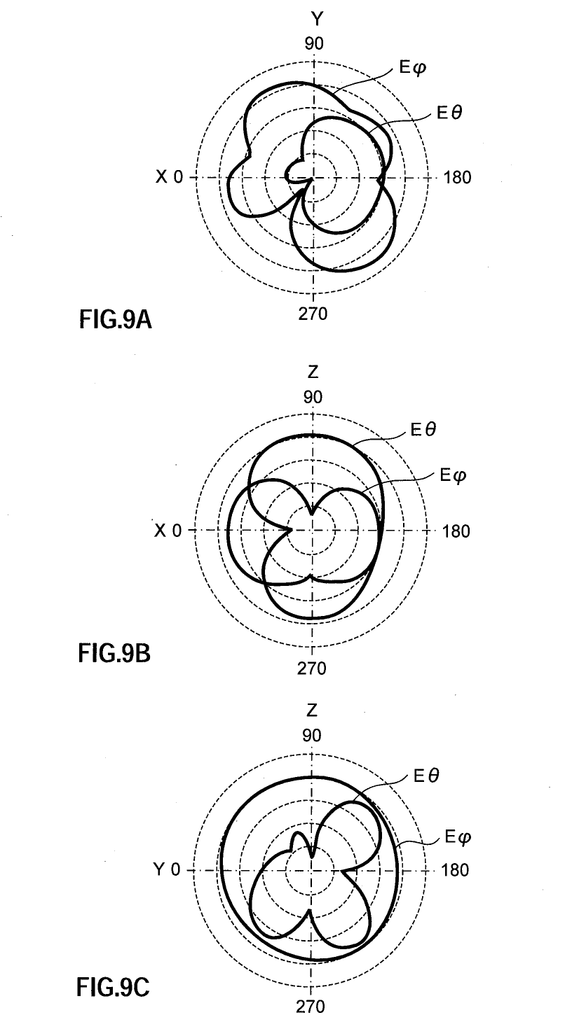

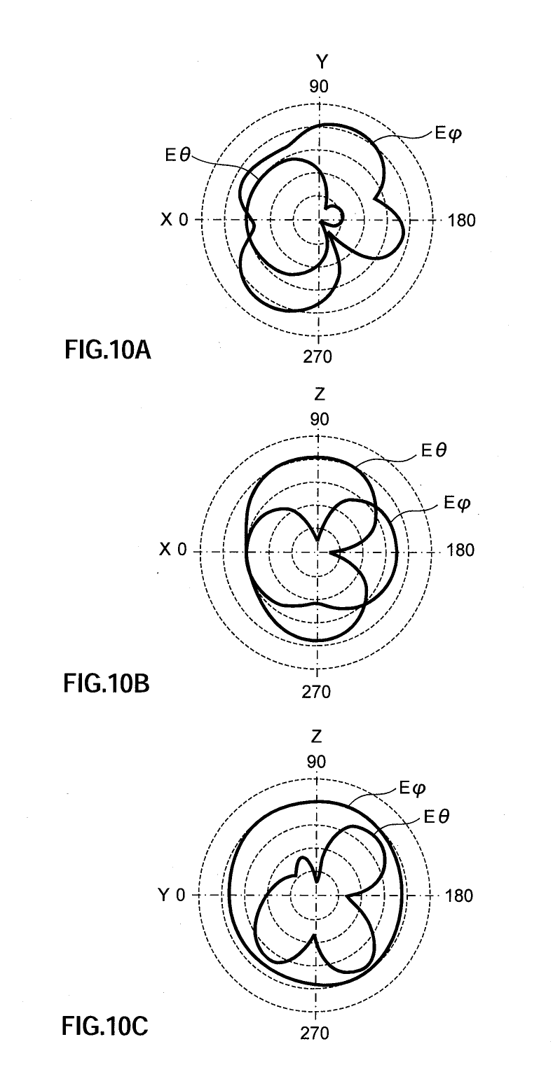

FIG. 9 and FIG. 10 show the radiation pattern characteristics when antennas placed as in FIG. 8 are adopted. Here, radiation pattern characteristics in center frequency 2.4 GHz have been investigated when the size of housing 30 is 45 mm×180 mm, the parameters of half-folded dipole antennas 10A and 10B are w1=w2=d=5 mm, wt=2 mm, h=7 mm, s=12.5 mm and b=1 mm.

FIG. 9 shows a radiation pattern of half-folded dipole antenna 10A and FIG. 10 shows a radiation pattern of half-folded dipole antenna 10B. For example, as known from FIG. 9B and

FIG. 10B, the radiation pattern in the X-Z plane is formed symmetrically toward the outside of housing 30. When the correlation coefficient between antennas 10A and 10B is found, a low value 0.08 is obtained. By this means, high MIMO performance can be realized by adopting the configuration according to the present embodiment.

Further, when the current distribution at center frequency 2.4 GHz has been investigated, it has been found out that current is distributed around the antenna elements in a concentrated manner. By this means, even when a terminal used by holding it in a hand, the influence upon antenna characteristic is little. Normally, for a mobile phone device, which is usually used by holding it in a hand, less influence upon a human body suggests that safe communication is possible in any use conditions.

### (Embodiment 3)

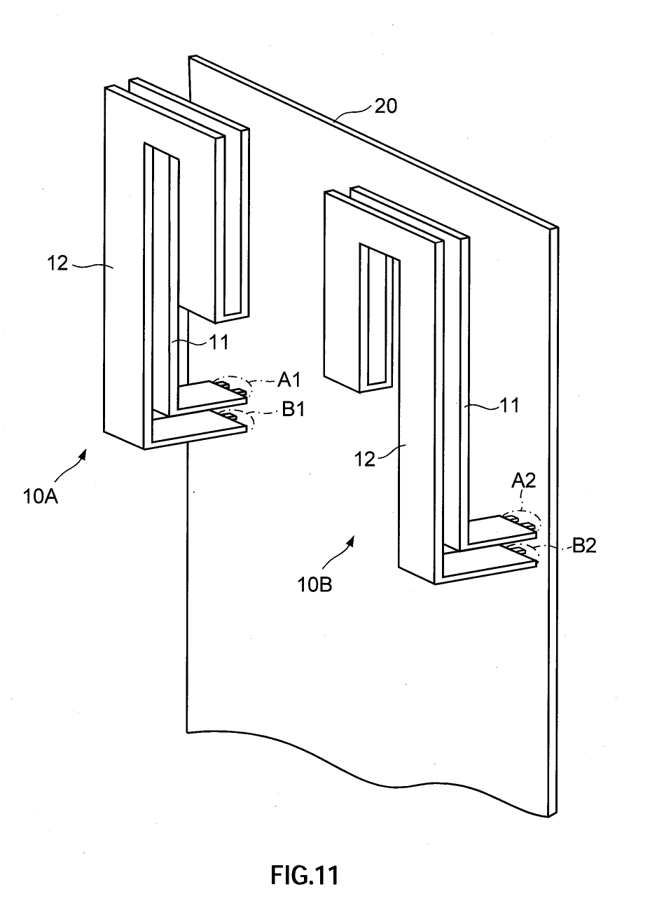

FIG. 11 shows an example of the configuration of half-folded dipole antenna according to the present embodiment. At half-folded dipole antennas 10A and 10B according to the present embodiment, gaps are provided between the antenna elements and the grounding parts in plate conductor 20, and resonant circuits A1 and A2 are loaded in these parts.

With the present embodiment, feeds B1 and B2 are grounded on upper element 12, and parallel resonant circuits (LC circuits) A1 and A2 are connected with bottom element 11.

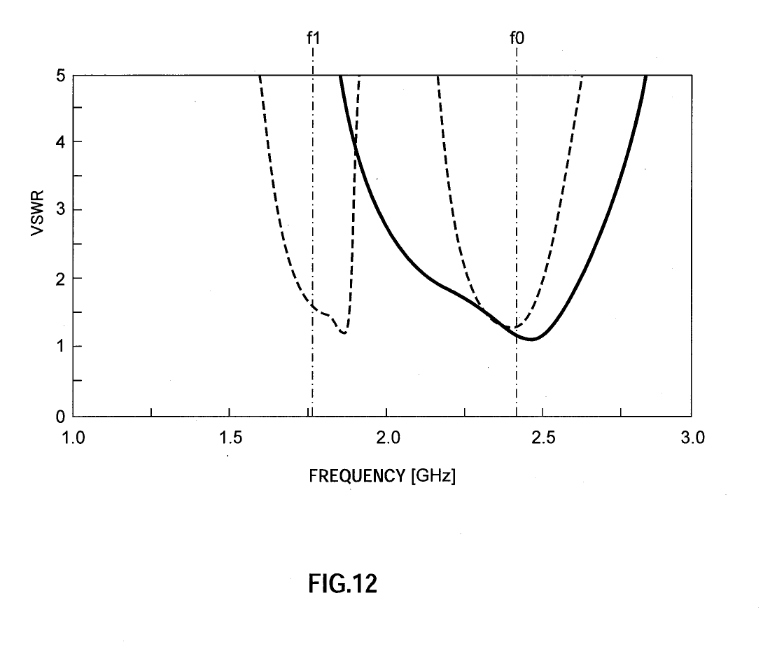

FIG. 12 shows the frequency characteristics of half-folded dipole antennas 10A and 10B when the configuration according to the present embodiment is adopted. The solid line shows the frequency characteristics in the cases where parallel resonant circuits are not provided (that is, bottom element 11 is grounded directly) or where parallel resonant circuits are operated in OFF mode.

Meanwhile, the dotted lines show the frequency characteristics in the cases where parallel resonant circuits are provided and operated in ON mode. By providing parallel resonant circuits, it is possible to acquire the low frequency band between 1.6 and 1.9 GHz that cannot be acquired when parallel resonant circuits are not provided (the solid line in the figure), in addition to the frequency band between 2.2 and 2.6 GHz.

By this means, multi frequency (multi resonance) can be achieved, so that it is possible to be adaptable to realize multi-band. Frequency bands can change to a certain extent by changing a circuit constant of a parallel resonant circuit.

In this way, according to the present embodiment, by providing parallel resonant circuits A1 and A2 for half-folded dipole antennas 10A and 10B, it is possible to achieve a half-folded dipole antenna that is wide band and is more adaptable to realize multi band.

The configurations of the above described Embodiments 1 to 3 can be implemented by combining these embodiments.

### (Another Embodiment)

Although cases have been explained with the above Embodiments 1 to 3 where a half-folded dipole antenna having a J-shaped face as disclosed in Non-Patent Documents 1 and 2 is applied to the present invention, the present invention is not limited to the above embodiments, and, a half-folded dipole antenna having a L-shaped face without short side parts 11d and 12d by keeping lengthening parameter s may be applied.

That is, a half-folded dipole antenna having a L-shaped face, and, furthermore, other half-folded dipole antennas having other shaped faces can achieve to realize wide band and improve frequency characteristics as described the above Embodiment 1 by making different the element widths of an upper element and bottom element.

Further, the half-folded dipole antenna having an L-shaped face in which short side parts 11d and 12d are omitted can improve MIMO performance by placing two half-folded dipole antennas each having an L-shaped face in which short side parts 11d and 12d are omitted, along two upper end corners of the housing of the mobile phone device, similar to above Embodiment

Further, a half-folded dipole antenna having an L-shaped face in which short parts 11d and 12d are omitted, and, furthermore, other half-folded dipole antennas having other shaped faces can achieve a half-folded dipole antenna that is wide band that is adaptable to realize multi band by providing a parallel resonant circuit, similar to above Embodiment 3.

### INDUSTRIAL APPLICABILITY

The half-folded dipole antenna of the present invention is suitable for use as an antenna built in a portable terminal that carries out MIMO communication. Further, the present invention is effective in technologies to communicate using a plurality of antennas besides MIMO communication, for example, AAA (Adaptive Array Antenna) communication.

1. A half-folded dipole antenna comprising:
a first antenna element formed in a shape of a letter J, one end of the first antenna element being connected with a conductor plate; and
a second antenna element formed in the shape of the letter J, having element widths that are different from the element widths of the first antenna element, and folded from the other end of the first antenna element to overlap with the first antenna element at a distance, one end of the second antenna element being connected with the conductor plate.

2. The half-folded dipole antenna according to claim 1, wherein, the first antenna element and second antenna element are each formed with a long part, a middle part and a short part, wherein:
the long part, the middle part and the short part are provided in ascending order of distance from where the first antenna element and second antenna element are connected with the conductor plate;
the element width of the short part varies between the first antenna element and second antenna element; and
the element width of the long part of one of the first antenna element and second antenna element on a feed side, is wider than the element width of the long part of the other antenna element on a non-feed side.

3. A portable terminal comprising:
a first half-folded dipole antenna and second half-folded dipole antenna that are placed along upper corners of a housing of the portable terminal,
wherein the first half-folded dipole antenna and second half-folded dipole antenna each comprise:
a first antenna element formed in a shape of a letter J, one end of the first antenna element being connected with a conductor plate; and
a second antenna element formed in the shape of the letter J, folded from the other end of the first antenna element to overlap with the first antenna element at a distance, one end of the second antenna element being connected with the conductor plate,
wherein the first antenna element and second antenna element of the first half-folded dipole antenna and second half-folded dipole antenna are each formed with a long part, a middle part and a short part, the long part, the middle part and the short part being provided in ascending order of distance from where the first antenna element and second antenna element are connected with the plate conductor; and
wherein the first half-folded dipole antenna and second half-folded dipole antenna are placed such that these long parts meet along each side of the housing.

4. The portable terminal according to claim 3, wherein the element widths vary between the first antenna element and second antenna element of the first half-folded dipole antenna and second half-folded dipole antenna.

5. A portable terminal comprising:
a first half-folded dipole antenna and second half-folded dipole antenna that are placed along upper corners of a housing of the portable terminal,
wherein the first half-folded dipole antenna and second half-folded dipole antenna each comprise:
a first antenna element formed in a shape of a letter J, one end of the first antenna element being connected with a conductor plate; and
a second antenna element formed in the shape of the letter J, folded from the other end of the first antenna element to overlap with the first antenna element at a distance, one end of the second antenna element being connected with the conductor plate; and
wherein the element widths vary between the first antenna element and second antenna element of the first half-folded dipole antenna and second half-folded dipole antenna.

6. A half-folded dipole antenna comprising:
a first antenna element formed in a shape of a letter J, one end of the first antenna element being connected with a conductor plate;
a second antenna element formed in the shape of the letter J, folded from the other end of the first antenna element to overlap with the first antenna element at a distance, one end of the second antenna element being connected with the conductor plate;
a feed connected with the end of the first antenna element; and
a resonant circuit connected with the end of the second antenna element,
wherein the element widths vary between the first antenna element and second antenna element.

7. (canceled)
